(19) United States
(12) Patent Application Publication
(10) Pub. No.: US 2025/0100375 A1
(43) Pub. Date: Mar. 27, 2025

(54) CENTER BEARING SUPPORT

(71) Applicant: NOK CORPORATION, Tokyo (JP)

(72) Inventor: Yoshihisa RYU, Tottori (JP)

(73) Assignee: NOK CORPORATION, Tokyo (JP)

(21) Appl. No.: 18/710,676

(22) PCT Filed: Dec. 8, 2022
(86) PCT No.: PCT/JP2022/045354

§ 371 Date: Nov. 29, 2024

(30) Foreign Application Priority Data
Dec. 20, 2021 (JP) 2021-206093

(51) Int. Cl. B60K 17/24; F16C 35/04

(52) U.S. Cl. CPC B60K 17/24; F16C 35/04

(57) ABSTRACT

A center bearing support suitable for suppressing the decrease in vibration absorbing capability in a high-frequency region is realized.

The center bearing support includes an outer ring 3 that has a cylindrical shape and is attached to a member on a vehicle body side in such a manner that an outer peripheral surface 3b thereof is in contact with the member, an inner ring 2 that has a cylindrical shape and is attached to the center bearing in such a manner that an inner peripheral surface 2b thereof is in contact with an outer periphery of the center bearing, and an elastic body 1 that is connected to an inner peripheral surface 3a of the outer ring 3 and an outer peripheral surface 2a of the inner ring 2 and expands in a bellows-like bent shape which is convex toward one direction along the propeller shaft between the inner peripheral surface 3a of the outer ring 3 and the outer peripheral surface 2a of the inner ring 2, wherein the elastic body 1 includes a base part 15 that has a shape of a bent plate and expands in the bellows-like bent shape while maintaining a constant thickness thereof, between the inner peripheral surface 3a of the outer ring 3 and the outer peripheral surface 2a of the inner ring 2, and a convex part 14 that is layered on a convex surface 11a of a bent portion of the base part 15 and protrudes toward one direction, and the base part 15 and the convex part 14 are integrally formed of an elastic material.

### TECHNICAL FIELD

The present invention relates to a center bearing support that elastically supports a center bearing rotatably mounted on an outer peripheral surface of a propeller shaft of an automobile that transmits a rotational driving force toward the vehicle body side of the automobile.

### DESCRIPTION OF THE RELATED ART

Conventionally, a center bearing support that elastically supports a center bearing rotatably mounted on an outer peripheral surface of a propeller shaft of an automobile or transmitting a rotational driving force toward the vehicle body side of the automobile has been known. The propeller shaft is often divided into a plurality of parts instead of a single part (one part) from the viewpoint of durability against shock and vibration, and the layout, and the center bearing and the center bearing support are usually arranged in the vicinity of such a dividing point. Hereinafter, a conventionally known general center bearing support will be briefly described.

FIG. 1 is a perspective view of a cross section of a conventionally known general center bearing support 10A.

The center bearing support 10A of FIG. 1 has a configuration in which an outer ring 3 that has a cylindrical shape and is attached to a member (not shown) on the vehicle body side of an automobile and an inner ring 2 that has a cylindrical shape and is attached to a center bearing (not shown) mounted to a propeller shaft of an automobile (not shown) are connected by an elastic body 1A. Here, the elastic body 1A is a member made of an elastic material, and extends in a bellows-like bent shape which is convex toward one direction (X direction in FIG. 1) along the propeller shaft.

The center bearing support 10A has a configuration in which such an elastic body 1A is interposed between the outer ring 3 and the inner ring 2, so that vibrations transmitted between the propeller shaft and the vehicle body side of the automobile are absorbed. It is generally known that such a vibration absorbing effect is larger when the spring constant (dynamic spring constant) in the vibration state of the elastic body 1A in a direction perpendicular to the shaft of the propeller shaft (vertical direction in FIG. 1) is lower. Here, with respect to the vibration in the direction, the elastic body 1A has a natural resonance frequency that is determined in proportion to the square root of the sum of the spring constant of the outer ring-side flexible part 13A and the spring constant of the inner ring-side flexible part 12A divided by the mass of the bend 11A. The dynamic spring constant described above is known to be high when the elastic body 1A resonates at such a resonance frequency, so that the vibration absorbing capability of the center bearing support 10A decreases in the frequency region around the resonance frequency of the elastic body 1A.

Here, as shown in FIG. 1, in an elastic body 1A of a conventionally known general center bearing support 10A, the thickness of the rubber-like elastic material from the outer ring 3 to the inner ring 2 is substantially constant. However, in the elastic body 1A having such a configuration, the frequency region around the resonance frequency of the elastic body 1A may overlap with the frequency region of the vibration of the propeller shaft or the vehicle body, and the vibration absorbing capability of the center bearing support 10A may decrease in such a frequency region. In order to avoid such a situation, some center bearing supports have devised shapes of elastic bodies so that the resonance frequency of the elastic body is shifted to the high frequency side (for example, refer to Patent Document 1).

FIG. 2 is a perspective view of a cross section of a center bearing support 10B having a devised shape of an elastic body 1B so that the resonance frequency of the elastic body 1B is shifted to the high frequency side.

In FIG. 2, the same components as those in FIG. 1 are denoted by the same reference numerals, and redundant description thereof will be omitted. As shown in FIG. 2, in the elastic body 1B, the thickness of the bend 11B is smaller than the thickness of the outer ring-side flexible part 13B and the inner ring-side flexible part 12B. In the elastic body 1B having such a configuration, the weight of the bend 11B is small, and therefore, the resonance frequency of the elastic body 1B is increased. Typically, the resonance frequency of the elastic body 1B can be adjusted to 1500 Hz or more. In the center bearing support 10B of FIG. 2, by shifting the resonance frequency of the elastic body 1B to the high frequency side in this way, the overlap between the frequency region around the resonance frequency of the elastic body 1B and the frequency region of the vibration of the propeller shaft or the vehicle body is reduced.

### CITATION LIST

### Patent Document

[Patent Document 1] JP-A-2013-226951

### SUMMARY OF THE INVENTION

### Problem to be Solved by the Invention

However, it is often required to actively absorb high-frequency vibration of a propeller shaft or a vehicle body, and the configuration of the elastic body 1B of FIG. 2 may not satisfy such demands. Therefore, in order to suppress a decrease in the vibration absorbing capability of the center bearing support in a high-frequency region, further contrivance is required.

In view of the above-described circumstances, the present invention aims to realize a center bearing support suitable for suppressing a decrease in the vibration absorbing capability in a high-frequency region.

### Means for Solving the Problems

In order to solve the above problem, the present invention provides the following center bearing support.
[1] A center bearing support for elastically supporting a center bearing rotatably mounted on an outer peripheral surface of a propeller shaft of an automobile for transmitting a rotational driving force toward a vehicle body side of the automobile comprising: an outer ring that has a cylindrical shape and is attached to a member on the vehicle body side in such a manner that an outer peripheral surface thereof is in contact with the member, an inner ring that has a cylindrical shape and is attached to the center bearing in such a manner that an inner peripheral surface thereof is in contact with an outer periphery of the center bearing, and an elastic body that is connected to an inner peripheral surface of the outer ring and an outer peripheral surface of the inner ring and expands in a bellows-like bent shape which is convex toward one direction along the propeller shaft between the inner peripheral surface of the outer ring and the outer peripheral surface of the inner ring, wherein the elastic body includes a base part that has a shape of a bent plate and expands in the bellows-like bent shape while maintaining a constant thickness thereof, between the inner peripheral surface of the outer ring and the outer peripheral surface of the inner ring, and a convex part that is layered on a convex surface which is a surface on the side of the one direction, of both surfaces of a bent portion of the base part and protrudes toward the one direction, and the base part and the convex part are integrally formed of an elastic material.
[2] The center bearing support according to [1], wherein a resonance frequency of the elastic body is 600 to 1000 Hz.
[3] The center bearing support according to [2], wherein a ratio of a volume of the convex part to a volume of the bent portion of the base part is 0.6 to 0.8.
[4] The center bearing support according to any one of [1] to [3], wherein the elastic body has a plurality of the convex parts at positions apart from each other.

In the present invention, due to the presence of a convex part that is layered on a convex surface of a base part having a constant thickness in the elastic body, the thickness of a bend of the elastic body composed of a bent portion of the base part and a convex part is larger than the thickness of the other part of the elastic body. Therefore, the mass of the bend is larger than that in the case where the convex part is not present, and thereby the resonance frequency of the elastic body is reduced. In the present invention, by shifting the resonance frequency of the elastic body to the low frequency side as described above, the overlap between the frequency region around the resonance frequency of the elastic body and the frequency region of the high-frequency vibration of the propeller shaft or the vehicle body is reduced. As a result, according to the present invention, a center bearing support suitable for suppressing a decrease in vibration absorbing capability in a high-frequency region is realized.

### BRIEF DESCRIPTION OF THE DRAWINGS

FIG. 1 This is a perspective view of a cross section of a conventionally known center bearing support.

FIG. 2 This is a perspective view of a cross section of the center bearing support in which the shape of the elastic body is devised so that the resonance frequency of the elastic body is shifted to the high frequency side.

FIG. 3 This is a diagram showing a center bearing support of an embodiment of the present invention together with a propeller shaft of an automobile.

FIG. 4 This is a perspective view of a cross section of a center bearing support of FIG. 3.

FIG. 5 This is a perspective view of a cross section of a center bearing support that is another embodiment of the present invention.

### MODE FOR CARRYING OUT THE INVENTION

Hereinafter, embodiments of the present invention will be described with reference to the drawings. It should be understood that the present invention is not limited to the following embodiment, and design changes, improvements, and the like can be made as appropriate based on ordinary knowledge of a person skilled in the art without departing from the spirit of the present invention.

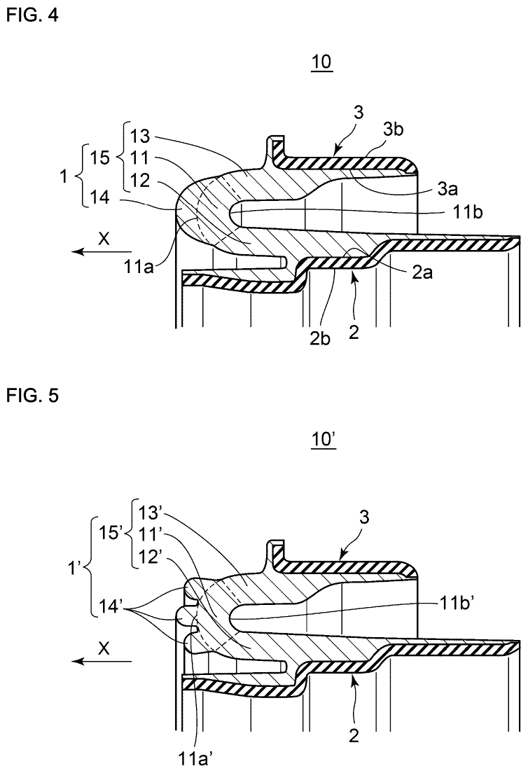

FIG. 3 is a diagram showing a center bearing support 10 of an embodiment of the present invention together with a propeller shaft 4 of an automobile 100, and FIG. 4 is a perspective view of a cross section of the center bearing support 10 of FIG. 3.

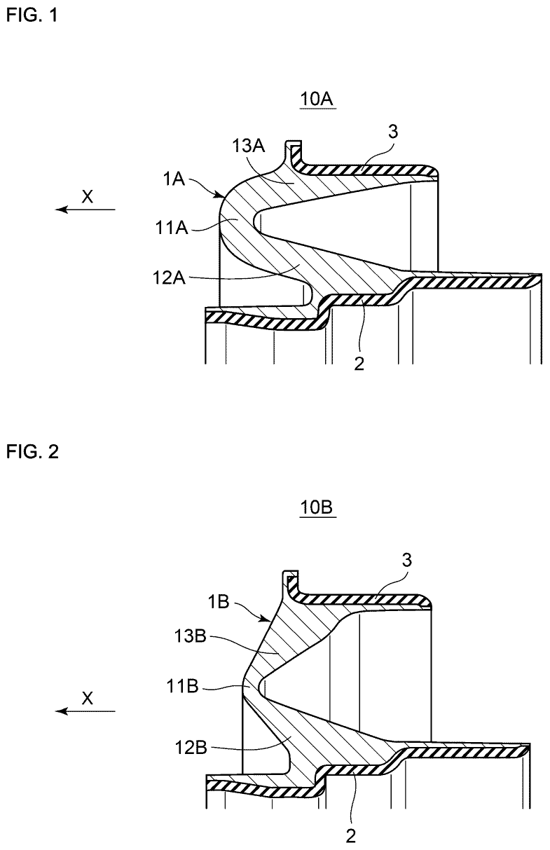

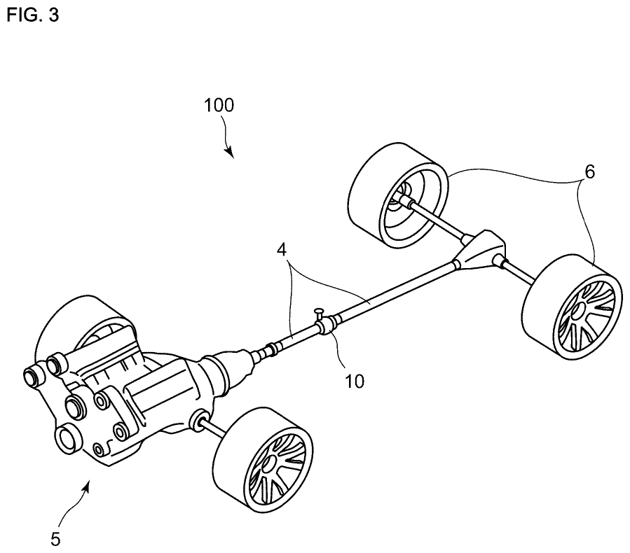

The propeller shaft 4 of the automobile 100 is one component of a driving force transmission mechanism for transmitting the rotational driving force obtained from an engine 5 to wheels 6 on the opposite side of the engine 5. The center bearing support 10 of the present embodiment is a member for elastically supporting a center bearing (not shown in FIG. 3 because it is covered with the center bearing support 10) rotatably mounted on the outer peripheral surface of the propeller shaft 4 toward the vehicle body side (not shown) of the automobile 100. As for the center bearing, conventionally known one, for example, the same one as the center bearing of Patent Document 1 can be employed. The propeller shaft 4 of FIG. 1 is not a single unit (one part), but is divided into two parts in the vicinity of the center bearing support 10 from the viewpoint of durability against impact and vibration and layout.

As shown in the perspective view of the cross section of FIG. 4, the center bearing support 10 comprises an outer ring 3, an inner ring 2 and an elastic body 1.

The outer ring 3 is a cylindrical member attached to a member (not shown) on the vehicle body (not shown) side of the automobile 100 shown in FIG. 3 while the outer peripheral surface 3b of the outer ring 3 is in contact with the member on the vehicle body side. As the outer ring 3, for example, a cylindrical member made of metal can be employed. The outer ring 3 does not need to be a single component, and may be a combination of a plurality of components to form a shape similar to a cylinder (cylindrical shape). Examples of the member on the vehicle body side include a bracket fixed to the vehicle body side.

The inner ring 2 is a cylindrical member attached to the center bearing while the inner peripheral surface 2b of the inner ring 2 is in contact with the outer periphery of a center bearing (not shown) attached to the propeller shaft 4 of the automobile 100 of FIG. 3. As the inner ring 2, for example, a cylindrical member made of metal can be employed. The inner ring 2 does not need to be a single component, and may be a combination of a plurality of components to form a shape similar to a cylindrical shape.

The elastic body 1 is a member made of an elastic material that is connected to the inner peripheral surface 3a of the outer ring 3 and the outer peripheral surface 2a of the inner ring 2. The elastic body 1 expands in a bellows-like bent shape which is convex toward one direction (X direction in FIG. 4) along the propeller shaft 4 (see FIG. 3) between the inner peripheral surface 3a of the outer ring 3 and the outer peripheral surface 2a of the inner ring 2.

In the center bearing support 10, such an elastic body 1 is interposed between the outer ring 3 and the inner ring 2, so that vibrations transmitted between the propeller shaft 4 (see FIG. 3) and the vehicle body (not shown) side of the automobile 100 (see FIG. 3) are absorbed.

Hereinafter, the elastic body 1 will be described in more detail.

As shown in FIG. 4, the elastic body 1 includes a base part 15 and a convex part 14 as constituent parts thereof, and the elastic body 1 is made by integrally forming the base part 15 and the convex part 14 from the above-described elastic material.

Here, the base part 15 is a part that has a shape of a bent plate and expands in the above-described bellows-like bent shape while maintaining a constant thickness thereof, between the inner peripheral surface 3a of the outer ring 3 and the outer peripheral surface 2a of the inner ring 2. Here, “maintaining a constant thickness thereof” means that the base part 15 having a plate shape has the same thickness at any position, and does not necessarily mean that the same thickness is strictly maintained at any position of the base part 15 having a plate shape.

On the other hand, a convex part 14 is a part layered on a convex surface 11a, of the convex surface 11a and the concave surface 11b, which are both surfaces of the bent portion of the base part 15 (the base bend 11 described later), facing the X direction in FIG. 4 and protrudes toward the X direction.

As shown in FIG. 4, due to the presence of the convex part 14 layered on the convex surface 11a of the base part 15 having a constant thickness in the elastic body 1, the thickness of the bend of the elastic body 1 composed of the bent portion of the base part 15 (base bend 11 described later) and the convex part 14 is larger than the thickness of the other part of the elastic body 1. Therefore, the mass of the bend is larger than that in the case where the convex part 14 is not present, and thereby the resonance frequency of the elastic body 1 is reduced. In the present embodiment, by shifting the resonance frequency of the elastic body 1 to the low frequency side as described above, the overlap between the frequency region around the resonance frequency of the elastic body 1 and the frequency region of the high-frequency vibration of the propeller shaft 4 (see FIG. 3) or the vehicle body of the automobile 100 (see FIG. 3) is reduced. As a result, according to the present embodiment, a center bearing support suitable for suppressing a decrease in the vibration absorbing capability in a high-frequency region is realized.

Hereinafter, the elastic body 1 will be described in more detail.

As described above, the resonance frequency of the elastic body 1 can be lowered due to the presence of the convex part 14, but it is preferable that the resonance frequency of the elastic body 1 is 600 to 1000 Hz by adjusting the size of the convex part 14.

According to such a configuration, the overlap between the frequency region around the resonance frequency of the elastic body 1 and the frequency region of the high-frequency vibration of the propeller shaft 4 (see FIG. 3) or the vehicle body of the automobile 100 (see FIG. 3) can be more reliably reduced.

Here, as shown in FIG. 4, when the base part 15 is roughly divided according to the shape of the constituting parts, the base part 15 is mainly constituted by three parts of an outer ring-side flexible part 13, an inner ring-side flexible part 12, and a base bend 11. The outer ring-side flexible part 13 is a part extending from the inner peripheral surface 3a of the outer ring 3 in a cylindrical shape with a slight taper. On the other hand, the inner ring-side flexible part 12 is a part extending from the outer peripheral surface 2a of the inner ring 2 in a cylindrical shape with a slight taper. The base bend 11 is a part having a shape of a bent plate as indicated by a dotted line in FIG. 4, in which both ends are connected to the outer ring-side flexible part 13 and the inner ring-side flexible part 12, and is a part corresponding to the “bent portion of the base part 15” described above. Both the convex surface 11a and the concave surface 11b, which are both surfaces of the base bend 11, are curved, but the circles corresponding to the respective radii of curvature of the convex surface 11a and the concave surface 11b (see FIG. 4) are concentric with each other.

At this time, the ratio of the volume of the convex part 14 to the volume of the base bend 11 is preferably 0.6 to 0.8.

According to such a configuration, the resonance frequency of the elastic body 1 is likely to fall within the range of 600 to 1000 Hz.

In the above embodiment, only one convex part 14 is present in the elastic body 1, but a plurality of similar convex parts may be present in the present invention. Such an embodiment will be described below.

FIG. 5 is a perspective view of a cross section of a center bearing support 10′ of another embodiment of the present invention separate from FIG. 4.

In FIG. 5, the same components as those in FIG. 4 are denoted by the same reference numerals, and redundant description thereof will be omitted. The center bearing support 10′ of FIG. 5 differs from the center bearing support 10 of FIG. 4 in that an elastic body 1′ having a plurality of convex parts 14′ (specifically, three convex parts 14′) is employed. Except for this point, the center bearing support 10′ of FIG. 5 has the same configuration as the center bearing support 10 of FIG. 4.

That is, also in the elastic body 1′ of FIG. 5, a base part 15′ having a constant thickness has an outer ring-side flexible part 13′ and an inner ring-side flexible part 12′ extending in a cylindrical shape with a slight taper, and has a base bend 11′ having both ends connected to the outer ring-side flexible part 13′ and the inner ring-side flexible part 12′ (refer to a dotted line part in the drawing). Here, the circles corresponding to the respective radii of curvature of cross sections of the convex surface 11a′ and the concave surface 11b′ of the base bend 11′ are concentric with each other. However, unlike the elastic body 1 of FIG. 4, the elastic body 1′ of FIG. 5 includes a plurality of convex parts 14′ (specifically, three convex parts 14′) at positions apart from each other on the convex surface 11a′ of the base part 15′.

Also in the center bearing support 10′ of FIG. 5, due to the presence of the three convex parts 14′, the thickness of the bend of the elastic body 1 composed of the base bend 11′ and the three convex parts 14′ is larger than the thickness of the other parts of the elastic body 1′.

Accordingly, the resonance frequency of the elastic body 1′ is shifted to the low frequency side, and the overlap between the frequency region around the resonance frequency of the elastic body 1 and the frequency region of the high-frequency vibration of the propeller shaft 4 (see FIG. 3) or the vehicle body of the automobile 100 (see FIG. 3) is reduced.

Here, in general, if the thickness of the bend of the elastic body is larger than the thickness of the other part, there is a concern that the followability of the axial displacement of the propeller shaft 4 (see FIG. 3) decreases and the durability of the elastic body decreases.

However, in the elastic body 1′ of FIG. 5, since the three convex parts 14′ are disposed at positions apart from each other, a decrease in the followability is suppressed as compared with a case where a single convex part 14 is present at one position as shown in FIG. 4. As a result, in the center bearing support 10′ of FIG. 5, the durability of the elastic body 1′ is improved.

Also in the center bearing support 10′ of FIG. 5, the resonance frequency of the elastic body 1′ is preferably 600 to 1000 Hz, and the ratio of the volume of the entire convex part 14′ (the sum of the volumes of the three convex parts 14′) to the volume of the base bend 11′ is preferably 0.6 to 0.8. As described above, since the resonance frequency is 600 to 1000 Hz, the overlap between the frequency region around the resonance frequency of the elastic body 1′ and the frequency region of the high-frequency vibration of the propeller shaft 4 (see FIG. 3) or the vehicle body of the automobile 100 (see FIG. 3) is more reliably reduced. When the ratio is 0.6 to 0.8, the resonance frequency is likely to fall within the range of 600 to 1000 Hz.

The above is the description of the embodiments of the present invention.

In the above description, the cases where the number of convex part is one and three have been described, but in the present invention, an embodiment in which the number of convex part is two or four or more may be employed.

### INDUSTRIAL APPLICABILITY

The present invention is useful for realizing a center bearing support suitable for suppressing a decrease in vibration absorbing capability in a high-frequency region.

### DESCRIPTION OF REFERENCE NUMERALS

1, 1′, 1A, 1B: elastic body
2: inner ring
2a: outer peripheral surface
2b: inner peripheral surface
3: outer ring
3a: inner peripheral surface
3b: outer peripheral surface
4: propeller shaft
5: engine
6: wheel
10, 10′, 10A, 10B: center bearing support
11, 11′: base bend
11a: convex surface
11b: concave surface
12, 12′: inner ring-side flexible part
13, 13′: outer ring-side flexible part
14, 14′: convex part
15, 15′: base part
100: automobile

1. A center bearing support for elastically supporting a center bearing rotatably mounted on an outer peripheral surface of a propeller shaft of an automobile for transmitting a rotational driving force toward a vehicle body side of the automobile, comprising:
an outer ring that has a cylindrical shape and is attached to a member on the vehicle body side in such a manner that an outer peripheral surface thereof is in contact with the member,
an inner ring that has a cylindrical shape and is attached to the center bearing in such a manner that an inner peripheral surface thereof is in contact with an outer periphery of the center bearing, and
an elastic body that is connected to an inner peripheral surface of the outer ring and an outer peripheral surface of the inner ring and expands in a bellows-like bent shape which is convex toward one direction along the propeller shaft between the inner peripheral surface of the outer ring and the outer peripheral surface of the inner ring, wherein
the elastic body includes a base part that has a shape of a bent plate and expands in the bellows-like bent shape while maintaining a constant thickness thereof, between the inner peripheral surface of the outer ring and the outer peripheral surface of the inner ring, and a convex part that is layered on a convex surface which is a surface on the side of the one direction, of both surfaces of a bent portion of the base part and protrudes toward the one direction, and the base part and the convex part are integrally formed of an elastic material.

2. The center bearing support according to claim 1, wherein a resonance frequency of the elastic body is 600 to 1000 Hz.

3. The center bearing support according to claim 2, wherein a ratio of a volume of the convex part to a volume of the bent portion of the base part is 0.6 to 0.8.

4. The center bearing support according to any one of claims 1 to 3, wherein the elastic body has a plurality of the convex parts at positions apart from each other.
